(19) United States
(12) Patent Application Publication
(10) Pub. No.: US 2007/0145014 A1
(43) Pub. Date: Jun. 28, 2007

(54) Polishing composition for glass substrate

(75) Inventors: Kazuhiko Nishimoto, Wakayama-shi (JP); Yasuhiro Yoneda, Wakayama-shi (JP); Mami Shirota, Wakayama-shi (JP)

Correspondence Address: BIRCH STEWART KOLASCH & BIRCH, PO BOX 747, FALLS CHURCH, VA, 22040-0747, US

(73) Assignee: Kao Corporation

(21) Appl. No.: 11/642,645

(22) Filed: Dec. 21, 2006

(30) Foreign Application Priority Data
Dec. 22, 2005 (JP) 2005-370536

(51) Int. Cl. B44C 1/22; C09K 13/00; C03C 15/00

(52) U.S. Cl. 216/97; 216/31; 216/88; 252/79.1

(57) ABSTRACT

The present invention provides a polishing composition for a glass substrate having a pH of from 0.5 to 5, containing a silica of which primary particles have an average particle size of from 5 to 50 nm and an acrylic acid/sulfonic acid copolymer having a weight-average molecular weight of from 1,000 to 5,000; and a method for manufacturing a glass substrate using the polishing composition. The polishing composition for a glass substrate can be suitably used, for example, in the manufacture of glass hard disks, aluminosilicate glass for reinforced glass substrates, glass ceramic substrates (crystallized glass substrates), synthetic quartz glass substrates (photomask substrates), and the like.

### FIELD OF THE INVENTION

The present invention relates to a polishing composition for a glass substrate and a method for manufacturing a glass substrate using the polishing composition.

### BACKGROUND OF THE INVENTION

Conventionally, in the fields of semiconductor devices and magnetic disk recording devices, various polishing compositions have been studied in order to manufacture a substrate having excellent surface qualities inexpensively. In the polishing composition mentioned above, for example, aluminum oxide (hereinafter also referred to as alumina) abrasive grains having average particle sizes around 1 μm have been well used as an abrasive from the viewpoint of increasing a polishing rate and surface smoothness (JP2001-64631 A, and the like).

In addition, in recent years, from the viewpoint of economically obtaining a substrate having excellent surface qualities being capable of realizing higher density, cerium oxide (hereinafter also referred to as ceria) having average particle sizes less than 1 μm has been used as an abrasive for a final polishing composition for a glass substrate. However, the polishing composition has disadvantages in dispersion stability and detergency.

Further, recently, for even higher density, more excellent surface qualities are demanded on a glass substrate. In order to realize the demand, silicon dioxide (hereinafter also referred to as silica) has been started to be suitably used as an abrasive of a final (finish) polishing composition. However, when a silica is used as an abrasive, polishing rate is generally very low while surface qualities are improved as compared to the case where ceria is used, thereby making it uneconomical.

Therefore, a polishing composition which contains a silica and an acid has been proposed as a polishing composition capable of improving detergency and dispersibility which are disadvantages of ceria, thereby reducing surface roughness, and capable of increasing polishing rate which is a disadvantage of silica (JP2005-138197 A, and the like).

### SUMMARY OF THE INVENTION

The present invention relates to

[1] a polishing composition for a glass substrate having a pH of from 0.5 to 5, containing a silica of which primary particles have an average particle size of from 5 to 50 nm and an acrylic acid/sulfonic acid copolymer having a weight-average molecular weight of from 1,000 to 5,000; and

[2] a method for manufacturing a glass substrate, including the step of polishing a substrate to be polished with a polishing load of from 3 to 12 kPa while allowing the polishing composition as defined in the above [1] to be present between a polishing pad and the substrate to be polished.

### DETAILED DESCRIPTION OF THE INVENTION

In general, a polishing composition does not meet a satisfactory level for both surface smoothness and polishing rate. Therefore, it is highly significant to provide a means that is capable of manufacturing a substrate having excellent surface qualities at a high polishing rate, in other words, a means that can meet a satisfactory level for both economic advantage and surface smoothness.

The present invention has been accomplished remarking on the disadvantages, and relates to a polishing composition for a glass substrate which is capable of manufacturing a substrate having excellent surface qualities at a high polishing rate, and a method for manufacturing a glass substrate.

According to the present invention, a polishing composition for a glass substrate that is capable of manufacturing a substrate having excellent surface qualities at a high polishing rate, in other words, a polishing composition for a glass substrate that can meet a satisfactory level for both economic advantage and surface smoothness, and a method for manufacturing a glass substrate can be provided.

These and other advantages of the present invention will be apparent from the following description.

1. Polishing Composition for Glass Substrate

One of the features of the polishing composition for a glass substrate of the present invention (hereinafter also referred to as simply “the polishing composition of the present invention”) resides in that the polishing composition contains a silica of which primary particles have an average particle size of from 5 to 50 nm and an acrylic acid/sulfonic acid copolymer having a weight-average molecular weight of from 1,000 to 5,000, and has a pH of from 0.5 to 5. Since the polishing composition has the above feature, the polishing composition of the present invention can realize an economically advantageous polishing rate when the polishing composition is used in a polishing step of a glass substrate, and can give a polished substrate excellent surface smoothness. The surface smoothness is an important physical property for increasing density, especially for a hard disk substrate, and also an important physical property for improving exposure precision (pattern transfer precision) in a photomask substrate. Further, the surface smoothness is an important physical property for increasing integration in a quartz wafer substrate. The surface smoothness is representatively evaluated as, for example, a determinable surface roughness in a short wavelength of a wavelength of 10 μm or less in an atomic force microscope (AFM), and can be expressed as an average roughness Ra (AFM-Ra).

<<Silica>>

A polishing composition of the present invention contains a silica of which primary particles have an average particle size of from 5 to 50 nm. The silica usable in the present invention includes, for example, colloidal silica, fumed silica, and the like. In addition, as the silica, those subjected to surface modification with a functional group, those formed into a composite particle with a surfactant or other particles, and the like can be used. Among them, the colloidal silica is preferable from the viewpoint of reducing surface roughness and scratches on a substrate surface. These silicas may be used alone or in admixture of two or more kinds.

The colloidal silica is obtained by a water glass method in which an alkali metal silicate such as sodium silicate used as a raw material is subjected to a condensation reaction in an aqueous solution to allow particles to grow, or an alkoxysilane method in which an alkoxysilane such as tetraethoxysilane used as a raw material is subjected to a condensation reaction in water containing a water-soluble organic solvent such as an alcohol to allow particles to grow.

The fumed silica is obtained by a vapor phase method in which a volatile silicon compound such as silicon tetrachloride used as a raw material is hydrolyzed at a high temperature of 1000° C. or higher with an oxygen-hydrogen burner to allow particles to grow.

The silica has an average particle size of primary particles of from 5 to 50 nm. The average particle size is preferably from 7 to 50 nm, more preferably from 10 to 50 nm, and even more preferably from 10 to 45 nm, from the viewpoint of increasing polishing rate and from the viewpoint of reducing surface roughness.

In order to determine the average particle size of primary particles in the present invention, a method by an image analysis of an image observed by a transmission electron microscope (TEM) was used. Therefore, the photographs of the silica particles observed by a transmission electron microscope (JEM-2000 FX, commercially available from JEOL LTD.) at an acceleration voltage of 80 kV and a magnification of 10,000 to 50,000 are incorporated as image data with a scanner connected to a personal computer. The circular diameter (diameter of a circle having the same area as a projected area of the silica particles) of each silica particle is determined using an image analysis software (WinROOF, commercially available from MITANI CORPORATION), and considered as a diameter of the silica particles. After analyzing data for 1,000 or more silica particles, the volume of the silica particles are calculated from the diameters of the silica particles based on the analyzed data using a spreadsheet software “EXCEL” (commercially available from Microsoft Corporation). The particle size at 50% counted from a smaller particle size side of the primary particles in a cumulative particle size distribution on the volume basis (D50) is the average particle size of the primary particles as referred in the present invention.

In the case where secondary particles of the silica are formed, the average particle size of the secondary particles is preferably from 10 to 100 nm, more preferably from 15 to 90 nm, and even more preferably from 15 to 80 nm, from the viewpoint of reducing scratches and from the viewpoint of reducing surface roughness. The method for determining the particle size of secondary particles includes a dynamic light scattering method, an ultrasonic attenuation method, a capillary hydrodynamic fractionation (CHDF) method, and the like.

The silica is contained in an amount of preferably from 1 to 50% by weight, more preferably from 2 to 40% by weight, even preferably from 3 to 30% by weight, and even more preferably from 5 to 25% by weight, of the polishing composition, from the viewpoint of increasing polishing rate and economically advantageously improving surface qualities.

<<Acrylic Acid/Sulfonic Acid Copolymer>>

The polishing composition of the present invention contains an acrylic acid/sulfonic acid copolymer having a weight-average molecular weight of from 1,000 to 5,000. The acrylic acid/sulfonic acid copolymer as used in the present invention refers to a copolymer containing a monomer having a sulfonic acid group (hereinafter also referred to as “sulfonic acid group-containing monomer”) and a (meth)acrylic acid monomer as monomer components. The sulfonic acid group-containing monomer includes, for example, isoprenesulfonic acid, (meth)acrylamide-2-methylpropanesulfonic acid, styrenesulfonic acid, methallylsulfonic acid, vinylsulfonic acid, allylsulfonic acid, isoamylenesulfonic acid, and the like. Among them, isoprenesulfonic acid and (meth)acrylamide-2-methylpropanesulfonic acid are preferable. These sulfonic acid group-containing monomers may be used alone or in admixture of two or more kinds.

In addition, the acrylic acid/sulfonic acid copolymer in the present invention can contain a monomer component other than the sulfonic acid group-containing monomer and the (meth)acrylic acid monomer, within the range which would exhibit the effects of the present invention.

In the present invention, although not wanting to be limited by theory, it is presumed that surface roughness can be reduced by allowing a carboxyl group in the acrylic acid monomer constituting the above-mentioned acrylic acid/sulfonic acid copolymer to adsorb to the abrasive grains or polishing debris, and allowing a sulfonic acid group in the sulfonic acid group-containing monomer to disperse the absorbed substances. When the proportion of the sulfonic acid group-containing monomer in the monomers constituting the copolymer is lowered, i.e. when the acrylic acid monomer is contained in a larger proportion, the copolymer itself is more likely to be absorbed to the substrate, so that polishing rate is likely to be suppressed. On the contrary, when the acrylic acid monomer is contained in a smaller proportion, the copolymer itself is less likely to be absorbed to the abrasive grains or polishing debris, so that a dispersion effect of the absorbed substances by the sulfonic acid group is not likely to be sufficiently exhibited. Therefore, the sulfonic acid group-containing monomer is contained in a ratio of preferably from 3 to 90% by mole, more preferably from 5 to 80% by mole, even preferably from 5 to 70% by mole, even more preferably from 5 to 60% by mole, and even more preferably from 5 to 50% by mole, of all the monomers constituting the acrylic acid/sulfonic acid copolymer, from the viewpoint of reducing surface roughness and increasing polishing rate and from the viewpoint of residual deposition of the copolymer itself on the substrate. Here, the acrylic acid group containing a sulfonic acid group is counted as a sulfonic acid group-containing monomer.

A preferred acrylic acid/sulfonic acid copolymer includes, for example, a (meth)acrylic acid/isoprenesulfonic acid copolymer, a (meth)acrylic acid/(meth)acrylamide-2-methylpropanesulfonic acid copolymer, a (meth)acrylic acid/isoprenesulfonic acid/(meth)acrylamide-2-methylpropanesulfonic acid copolymer, and the like, from the viewpoint of reducing surface roughness and increasing polishing rate.

The above-mentioned acrylic acid/sulfonic acid copolymer is preferably water soluble in order to make up a constituent of the polishing composition. For example, the copolymer may be in the form of a salt. The counterion for forming a salt is not particularly limited, and one or more members selected from alkali metal ions such as sodium ion and potassium ion, ammonium ion, alkylammonium ions and the like can be used.

The acrylic acid/sulfonic acid copolymer is obtained by, for example, sulfonating a base polymer containing a diene structure or an aromatic structure according to a known method, for example, a method described in “Shin-Jikken Kagaku Koza (Lectures on New Experimental Chemistry) 14 (Yukikagobutsuno Goseito Hanno (Synthesis and Reaction of Organic Compounds) III, p. 1773, 1978), Edited by Shadanhojin Nippon Kagakukai,” or the like.

The acrylic acid/sulfonic acid copolymer has a weight-average molecular weight of preferably from 1,000 to 5,000, more preferably from 1,000 to 4,500, and even more preferably from 1,500 to 4,500, from the viewpoint of obtaining sufficient effect of dispersing silica and/or polishing debris, and from the viewpoint of increasing polishing rate.

The weight-average molecular weight of the acrylic acid/sulfonic acid copolymer can be determined based on a calculation of the determination results by gel permeation chromatography (GPC) using a calibration curve drawn with sodium polystyrenesulfonate as a standard sample. The GPC conditions are as follows.

[GPC Conditions]

Column: G4000PWXL+G2500PWXL

Eluent: 0.2 M Phosphate buffer/acetonitrile=9/1

Flow rate: 1.0 mL/min

Temperature: 40° C.

Sample: concentration 5 mg/mL, amount of injection 100 μL

The acrylic acid/sulfonic acid copolymer is contained in an amount of preferably 0.001% by weight or more, and more preferably 0.01% by weight or more, of the polishing composition, from the viewpoint of reducing surface roughness. In addition, the copolymer is contained in an amount of preferably 10% by weight or less, more preferably 5% by weight or less, even preferably 3% by weight or less, even more preferably 1% by weight or less, and even more preferably 0.5% by weight or less, of the polishing composition, from the viewpoint of increasing polishing rate. In other words, the copolymer is contained in an amount of preferably from 0.001 to 10% by weight, more preferably from 0.01 to 5% by weight, even preferably from 0.01 to 3% by weight, even more preferably from 0.01 to 1% by weight, and even more preferably from 0.01 to 0.5% by weight, of the polishing composition, from the viewpoint of reducing surface roughness and increasing polishing rate.

Also, as to the relationship of the formulation amounts of the silica and the copolymer, a concentration ratio of the silica to the copolymer in the polishing composition, i.e. concentration of the silica (% by weight)/concentration of the copolymer (% by weight), is preferably from 10 to 5,000, more preferably from 20 to 3,000, even preferably from 30 to 2,000, even more preferably from 40 to 1,000, and even more preferably from 45 to 500, from the viewpoint of increasing polishing rate and reducing surface roughness.

<<Water>>

As the water used in the present invention, ion-exchanged water, distilled water, ultrapure water or the like can be favorably used. The water is contained in an amount of preferably from 40 to 99% by weight, more preferably from 50 to 98% by weight, even more preferably from 50 to 97% by weight, and even more preferably from 50 to 95% by weight, from the viewpoint of maintaining fluidity of the polishing composition and increasing polishing rate.

<<pH>>

The polishing composition of the present invention has a pH of from 0.5 to 5, preferably from 0.5 to 4, and more preferably from 0.5 to 3, from the viewpoint of increasing polishing rate. The pH can be adjusted depending on the content of an acid. The acid includes an inorganic acid and an organic acid. The inorganic acid includes hydrochloric acid, nitric acid, sulfuric acid, phosphoric acid, a polyphosphoric acid, amide sulfuric acid, and the like. Also, the organic acid includes a carboxylic acid, an organic phosphonic acid, an amino acid, and the like. The carboxylic acid includes, for example, a monocarboxylic acid such as acetic acid, glycolic acid, and ascorbic acid; a dicarboxylic acid such as oxalic acid and tartaric acid; a tricarboxylic acid such as citric acid. The organic phosphoric acid includes 2-aminoethylphosphonic acid, 1-hydroxyethylidene-1,1-diphosphonic acid (HEDP), aminotri(methylenephosphonic acid), ethylenediaminetetra(methylenephosphonic acid), diethylenetriaminepenta(methylenephosphonic acid), and the like. In addition, the amino acid includes glycine, alanine, and the like. Among them, the inorganic acid, the carboxylic acid, and the organic phosphonic acid are preferable, from the viewpoint of reducing scratches. For example, hydrochloric acid, nitric acid, sulfuric acid, phosphoric acid, a polyphosphoric acid, glycolic acid, oxalic acid, citric acid, HEDP, aminotri(methylenephosphonic acid), ethylenediaminetetra(methylenephosphonic acid), or diethylenetriaminepenta(methylenephosphonic acid) is suitably used. These acids for adjusting pH may be used alone or in admixture of two or more kinds.

<<Optional Component>>

The polishing composition of the present invention can contain a salt of above-mentioned acid as an optional component, from the viewpoint of improving polishing rate. The counterion (cation) of the salt includes alkali metal ions such as sodium ion and potassium ion, ammonium ion, alkylammonium ions, and the like. Among them, the alkali metal ions are preferable. Also, other optional components include thickeners, dispersants, basic substances, surfactants, chelating agents, defoaming agents, anti-bacterial agents, anticorrosive agents, and the like.

These optional components are contained in an amount of preferably 5% by weight or less, more preferably 4% by weight or less, and even more preferably 3% by weight or less, of the polishing composition, from the viewpoint of increasing polishing rate.

<<Process for Preparing Polishing Composition>>

The polishing composition of the present invention can be prepared by mixing each of the above-mentioned components by a known method. Here, the concentration of each of the above-mentioned components may be any of a concentration during the preparation and a concentration upon use. The polishing composition is usually prepared as a concentrate and diluted upon use in many cases, from the viewpoint of economic advantages.

<<Glass Substrate>>

The material for a glass substrate which is an object to be polished with the polishing composition of the present invention includes, for example, quartz glass, soda-lime glass, aluminosilicate glass, borosilicate glass, aluminoborosilicate glass, non-alkaline glass, crystallized glass, glassy carbon, and the like. Among them, the aluminosilicate glass for a reinforced glass substrate, a glass ceramic substrate (crystallized glass substrate), or a synthetic quartz substrate is suitable for polishing. The aluminosilicate glass is preferable from the viewpoint that the aluminosilicate glass has excellent chemical durability, so that the generation of damages (defects in dent portion) during cleaning with an alkali which is carried out for the purpose of removing particles remaining on the substrate after polishing can be reduced, thereby giving an even higher surface qualities. In addition, the synthetic quartz glass is preferable from the viewpoint of being excellent in its optical properties such as transmittance.

The shape for the substrate is not particularly limited. For example, those having shapes containing planar portions such as discs, plates, slabs and prisms, or shapes containing curved portions such as lenses can be also used. Among them, the polishing composition of the present invention is excellent in polishing those having the disc-shaped or plate-like objects to be polished.

Since the polishing composition of the present invention is used in the step of polishing a glass substrate, an economically advantageous polishing rate can be realized and a polished substrate is imparted with excellent surface smoothness, and whereby a high-quality glass substrate having excellent surface properties can be manufactured economically.

The mechanism for reducing surface roughness on a substrate by using the polishing composition of the present invention is not elucidated, but is presumably as follows. As mentioned above, a steric effect caused by adsorption of the acrylic acid/sulfonic acid copolymer contained in the polishing composition on the surface of abrasive grains and/or polishing debris leads to the reduction of surface roughness by dispersion of the absorbed substances.

2. Method for Manufacturing Glass Substrate

One of the features of the method for manufacturing a glass substrate of the present invention resides in that the method includes the step of polishing a substrate to be polished with a polishing load of from 3 to 12 kPa while allowing the above-mentioned polishing composition to be present between a polishing pad and the substrate to be polished (hereinafter also referred to as “the polishing step A”). By using the method for manufacturing a glass substrate having the feature, a glass substrate having an excellent surface smoothness can be obtained at an economically advantageous polishing rate. The surface smoothness is an important physical property for realizing high density, especially for a hard disk substrate, and also an important physical property for improving exposure precision (pattern transfer precision) in a photomask substrate. Further, the surface smoothness is an important physical property for increasing integration in a quartz wafer substrate. Therefore, the method for manufacturing a glass substrate of the present invention is suitably used for manufacturing a glass hard disk substrate, manufacturing a photomask substrate and manufacturing a quartz wafer substrate.

<<Polishing Process>>

A process for polishing in the polishing step A includes a polishing process using a polishing machine. Specifically, the polishing process includes the steps of putting a substrate to be polished held with a carrier between polishing platens to which a polishing pad is attached, feeding the polishing composition of the present invention between the polishing pad and the substrate to be polished, and moving the polishing platens and/or the substrate to be polished, while applying a given pressure, thereby polishing the substrate to be polished while contacting with the polishing composition of the present invention.

The polishing machine for a glass substrate using the polishing composition of the present invention is not particularly limited, and a polishing machine comprising a jig (carrier, made of aramide or the like) for holding a substrate to be polished and a polishing cloth (a polishing pad) can be used. Among them, a double-sided polishing machine that is used in the polishing step is suitably used.

<<Polishing Load>>

The polishing load in the polishing step A is 3 kPa or more, preferably 4 kPa or more, more preferably 5 kPa or more, and even more preferably 5.5 kPa or more, from the viewpoint of increasing polishing rate, and polishing the substrate economically advantageously. Also, the polishing load is 12 kPa or less, preferably 11 kPa or less, more preferably 10 kPa or less, and even more preferably 9 kPa or less, from the viewpoint of improving surface qualities and relaxing residual stress on the substrate surface. Therefore, the polishing load is from 3 to 12 kPa, preferably from 4 to 11 kPa, more preferably from 5 to 10 kPa, and even more preferably from 5.5 to 9 kPa, from the viewpoint of increasing polishing rate and improving surface qualities.

<<Feeding Rate for Polishing Composition>>

The preferred feeding rate for the polishing composition in the polishing step A cannot be unconditionally determined because the feeding rate would differ depending upon the area of the polishing pad contacting the substrate to be polished and the total area of the substrate introduced, and further upon the kinds of the polishing composition. The feeding rate is preferably from 0.06 to 5 mL/min, more preferably from 0.08 to 4 mL/min, and even more preferably from 0.1 to 3 mL/min per unit area (1 cm²) of the substrate to be polished, from the viewpoint of increasing polishing rate and polishing a substrate economically advantageously.

<<Substrate to be Polished>>

The substrate to be polished includes the same substrate as the glass substrate mentioned above to which the polishing composition of the present invention is subject for polishing. The surface properties of the substrate before subjecting to the polishing step A are not particularly limited. For example, the substrate having surface properties such as an AFM-Ra of 1 nm or less is suitably used.

<<Step of Manufacturing Glass Substrate>>

In a case where the substrate to be polished is, for example, a glass hard disk substrate, the substrate is manufactured through the steps of subjecting a glass substrate obtained by a die press of a molten glass, or a method of cutting out the substrate from a sheet glass to a rough grinding step, a shaping step, a sidewall mirror-finishing step, a precision-grinding step, a polishing step, a cleaning step, and a step of manufacturing a magnetic disk.

In addition, generally, in the course of the manufacturing steps, in the case of a reinforced glass substrate, a chemical reinforcement step including the step of subjecting a substrate to a dip treatment in a heated chemically reinforced salt of potassium nitrate and sodium nitrate is carried out subsequent to a cleaning step, thereby substituting ions in the surface layer therewith. Also, in the case of a crystallized glass substrate, a crystallization step including the step of forming a crystal core by a heat treatment is previously carried out prior to a manufacturing step, thereby forming a crystalline phase.

In addition, for example, in the rough grinding step, alumina abrasive grains of #400 or so are used; in the shaping step, a cylindrical grinding stone is used; in the sidewall mirror-finishing step, a brush is used; and in the precision-grinding step, alumina abrasive grains of #1000 or so are used.

Generally, the polishing step can be divided into a first polishing step and a second polishing step, and further a final (finish) polishing step may be carried out for the purpose of improving surface qualities in many cases. Cerium oxide is preferably used in the first polishing step, and silica is preferably used in the final (finish) polishing step. Therefore, in the steps for manufacturing a substrate, it is preferable that the polishing composition of the present invention is used in the second polishing step or a subsequent step, and it is more preferable that the polishing composition is used in the final polishing step, from the viewpoint of remarkably reducing surface roughness, thereby obtaining excellent surface smoothness. In addition, the polishing step A is preferably employed in the second or final (finish) polishing step. Here, the finish polishing step refers at least to the last polishing step of the polishing steps when the polishing is carried out in plural steps.

After the polishing step, in order to remove the silica abrasive grains and polishing debris remaining on a glass substrate surface, the substrate is subjected to a scrub-cleaning and/or ultrasonication cleaning with a strong alkali using an aqueous NaOH or the like, to dissolve away the residual substance, and subsequently subjected to dip cleaning in ultrapure water, isopropanol or the like, and steam-drying with isopropanol or the like.

Thereafter, a seed layer, an undercoat layer, an intermediate layer, a magnetic layer, a protective layer, and a lubricating layer are each formed into a film, to provide a magnetic disk.

As to the glass hard disk substrate, smoothness that does not generate any read-write errors in a magnetic head is required. In other words, the substrate surface is earnestly desired to be excellent in planarization (roughness, waviness, and the like) and defects (projection portions such as abrasive grains, and dent portions such as scratches and pits). Among the steps for manufacturing a substrate, the polishing step plays a role for giving such excellent properties, and especially the second polishing step or the final (finish) polishing step is important.

<<Step of Manufacturing Photomask Substrate>>

In a case where a substrate to be polished is, for example, a photomask substrate, the substrate is manufactured through the steps of heat-fusing a synthetic quartz ingot in a columnar shape at a high temperature, subjecting the heat-fused product to hot working into a square block form, subjecting the hot-worked product to an annealing treatment to remove strains, and slicing the annealed product into thin pieces, to provide a thin, square-shaped synthetic quartz substrate, and generally subjecting the resulting substrate to a grinding step, a shoulder-working step, a polishing step, a cleaning step, and a step of manufacturing photomask.

Also, the grinding step includes the steps of, for example, first and second step of grinding steps (primary lapping, secondary lapping), and smoothens a substrate surface to a certain extent. In the grinding step, a hard abrasive, such as silicon carbide or alumina, is widely used. Thereafter, side surfaces thereof are polished in a state where plural substrates are stacked together, and a shoulder side surface of each substrate is subjected to mirror processing.

The polishing step is generally divided into a first polishing step and a second polishing step. In many cases, a final (finish) polishing step is further carried out, for the purpose of improving surface quality. Here, cerium oxide is preferably used in the first polishing step, and silica is preferably used in the final (finish) polishing step. Therefore, the polishing composition of the present invention is preferably used in a second polishing step or subsequent steps in the steps of manufacturing the substrate. It is more preferable that the polishing composition of the present invention is used in the finish polishing step, from the viewpoint of remarkably reducing the surface roughness and obtaining an excellent surface smoothness. In addition, it is preferable that the polishing step A is employed as a second polishing step or a final (finish) polishing step. Here, the finish polishing step refers to at least a final polishing step when plural polishing steps are employed.

After the polishing step, in order to remove silica abrasive grains and polishing debris remaining on the synthetic quartz substrate surface, the substrate surface is cleaned with, for example, a neutral detergent, and the substrate is further immersed in a chemical solution having solvency for the synthetic quartz glass (a strong alkali solution, HF solution, or the like), thereby etching an outermost layer of the polishing surface of the substrate to remove impurities. Next, the substrate is subjected to immersion cleaning with pure water, isopropanol or the like, and steam drying with isopropanol or the like.

Thereafter, a metal-film made of chromium or the like is applied thereto by vapor deposition or sputtering to provide a mask blanks substrate, and a resist or the like is applied to the substrate, and thereafter the substrate is exposed and etched, thereby forming patterns on the surface, to provide a photomask substrate.

The photomask substrate is required to have smoothness that can highly precisely expose fine patterns. In other words, the photomask substrate is desired to have planarization (roughness, waviness, and the like) of the substrate surface and excellent in defects (projection portion of abrasive grains, and the like, and dent portion of scratches, pits, and the like). The polishing step plays a key role in the steps of manufacturing the substrate, and a second polishing step or a final (finish) polishing step is even more important.

<<Step of Manufacturing Quartz Wafer Substrate>>

In a case where a substrate to be polished is, for example, a quartz wafer substrate, the substrate is manufactured through the steps of slicing a synthetic quartz ingot in a columnar shape, to provide a disc-shaped synthetic quartz substrate, and generally subjecting the resulting substrate to a grinding step, a shoulder-working step, a polishing step, a cleaning step, and a step of forming a silicon layer.

Also, the grinding step includes the steps of, for example, first and second step of grinding steps (primary lapping, secondary lapping), and smoothens a substrate surface to a certain extent. In the grinding step, a hard abrasive, such as silicon carbide or alumina, is widely used. Thereafter, side surfaces thereof are polished in a state where plural substrates are stacked together, and a shoulder side surface of each substrate is subjected to mirror processing.

The polishing step is generally divided into a first polishing step and a second polishing step. In many cases, a final (finish) polishing step is further carried out, for the purpose of improving surface quality. Here, cerium oxide is preferably used in the first polishing step, and silica is preferably used in the final (finish) polishing step. Therefore, the polishing composition of the present invention is preferably used in a second polishing step or subsequent steps in the steps of manufacturing the substrate. It is more preferable that the polishing composition of the present invention is used in the finish polishing step, from the viewpoint of remarkably reducing the surface roughness and obtaining an excellent surface smoothness. In addition, it is preferable that the polishing step A is employed as a second polishing step or a final (finish) polishing step. Here, the finish polishing step refers to at least a final polishing step when plural polishing steps are employed.

After the polishing step, in order to remove silica abrasive grains and polishing debris remaining on the synthetic quartz substrate surface, the substrate surface is cleaned with, for example, a neutral detergent, and the substrate is further immersed in a chemical solution having solvency for the synthetic quartz glass (a strong alkali solution, HF solution, or the like), thereby etching an outermost layer of the polishing surface of the substrate to remove impurities. Next, the substrate is subjected to immersion cleaning with pure water, isopropanol or the like, and steam drying with isopropanol or the like.

Further, thereafter, a SOI (Silicon On Insulator) wafer can be obtained by display device or pasting together method (see Oyobutsuri (Applied Physics), 11, 1192 (1997) by the formation of a polycrystalline silicon film by means of CVD (Chemical Vapor Deposition) or the like, depending upon its purpose.

The quartz wafer substrate is required to have smoothness that can highly precisely expose fine patterns. In other words, the synthetic quarts wafer substrate is desired to have planarization (roughness, waviness, and the like) of the substrate surface and excellent in defects (projection portion of abrasive grains, and the like, and dent portion of scratches, pits, and the like). The polishing step plays a key role in the steps of manufacturing the substrate, and a second polishing step or a final (finish) polishing step is even more important.

<<Polishing Pad>>

As to the polishing pad, a polishing pad made of an organic polymer-based foamed article, a non-foamed article, or a nonwoven fabric can be used. For example, a sueded rigid pad made of urethane is suitably used in the first polishing step, and a sueded soft pad made of urethane is suitably used in the second-polishing step and the final polishing step.

The polishing composition of the present invention is suitable for the polishing step for a glass substrate, and even more preferably for a polishing step for reducing surface roughness (AFM-Ra) of the substrate after polishing to 0.2 nm or less.

In addition, the polishing composition of the present invention is suitably used in a second polishing step or a subsequent step, and the polishing composition can be applied in the same manner to a polishing step other than above, for example, a first polishing step or a lapping step. Even more, the present invention is suitably used for manufacturing of a glass hard disk substrate, manufacturing a photomask substrate, and manufacturing a quartz wafer substrate.

When the polishing composition of the present invention is used in the second polishing step or the subsequent step, in order to avoid admixture of the polishing composition used in the previous steps or admixture of polishing debris, the polishing steps can be each carried out in separate polishing machines. When each of separate polishing machines is used, it is preferable that the substrate is cleaned for every polishing step.

As the process for feeding a polishing composition, a process including the step of feeding a polishing composition in the state that the constituents of the polishing composition are sufficiently mixed in advance, between a polishing pad and a substrate to be polished with a pump or the like; a process including the step of feeding a polishing composition prepared by mixing the constituents in the feed lines and the like immediately before polishing; a process including the step of separately feeding a silica slurry and an aqueous solution prepared by dissolving an acrylic acid/sulfonic acid copolymer to a polishing machine; or the like can be used.

The polishing composition of the present invention, or the substrate manufactured by using the method for manufacturing a glass substrate of the present invention in the manner as described above has excellent surface smoothness, and one that has a surface roughness (AFM-Ra) of, for example, 0.2 nm or less, preferably 0.19 nm or less, and more preferably 0.18 nm or less can be obtained.

Therefore, when the substrate is, for example, a memory hard disk substrate, the substrate can meet the requirement of a recording density of 100 G bits/inch², even more 125 G bits/inch².

3. Method for Reducing Surface Roughness of Glass Substrate

In order to effectively reduce surface roughness, a substrate to be polished is polished using the polishing composition of the present invention, or a polishing composition prepared by mixing each component so that a polishing composition is like the polishing composition of the present invention. According to the method, surface roughness of the substrate to be polished can be remarkably reduced, and a substrate having excellent surface qualities can be manufactured economically because a polishing rate is high. Therefore, the present invention also relates to the method for reducing surface roughness of a glass substrate including the step of polishing the substrate to be polished with a polishing load of from 3 to 12 kPa while allowing the above-mentioned polishing composition to be present between a polishing pad and the substrate to be polished.

The polishing step in the method for reducing surface roughness may be the same as the polishing step A of the method for manufacturing a glass substrate of the present invention.

### EXAMPLES

The following examples further describe and demonstrate embodiments of the present invention. The examples are given solely for the purposes of illustration and are not to be construed as limitations of the present invention.

1. Glass Hard Disk Substrate

<<Substrate to Be Polished>>

A glass substrate made of aluminosilicate for hard disks, having a thickness of 0.635 mm, an outer diameter of 65 mm and an inner diameter of 20 mm, previously subjected to first and second polishing steps with a polishing composition containing ceria as an abrasive so as to provide a surface roughness AFM-Ra of 0.3 nm was used as a substrate to be polished.

### Example 1

A polishing composition containing a colloidal silica slurry (commercially available from Du Pont K.K., average particle size of primary particles: 20 nm, concentration of silica particles: 40% by weight, the balance being water) as an abrasive, in an amount of 5.0% by weight based on net silica particles, an acrylic acid/acrylamide-2-methylpropanesulfonic acid copolymer (proportion of sulfonic acid group-containing monomers: 11% by mole, weight-average molecular weight: 2,000, solid content: 40% by weight, a product neutralized with sodium) in an amount of 0.10% by weight based on net copolymer, HEDP (commercially available from Solutia Japan Limited, solid content: 60% by weight) in an amount of 0.13% by weight based on net copolymer, and sulfuric acid (commercially available from Wako Pure Chemical Industries, Ltd., concentrated sulfuric acid, special grade reagent) in an amount of 0.40% by weight based on net copolymer, as acids, and the balance being ion-exchanged water was prepared. The order of mixing each component was such that a given amount of an aqueous solution of the above copolymer diluted five-folds with ion-exchanged water was added to an aqueous solution of HEDP and sulfuric acid while stirring, and finally the colloidal silica slurry was added thereto and mixed, to provide a polishing composition. The resulting polishing composition had a pH of 1.8.

### Example 2

The same procedures as in Example 1 were carried out except that concentrations of HEDP and sulfuric acid based on net copolymer contained in a polishing composition was a half the concentrations in Example 1, to provide a polishing composition. The resulting polishing composition had a pH of 3.0.

### Example 3

The same procedures as in Example 1 were carried out except that a colloidal silica slurry (commercially available from Du Pont K.K., average particle size of primary particles: 30 nm, concentration of silica particles: 40% by weight, the balance being water) was used as an abrasive, to provide a polishing composition. The resulting polishing composition had a pH of 1.7.

### Example 4

The same procedures as in Example 3 were carried out except that concentration of a copolymer based on net copolymer contained in a polishing composition was 0.05% by weight, to provide a polishing composition. The resulting polishing composition had a pH of 1.8.

### Example 5

The same procedures as in Example 1 were carried out except that the copolymer was changed to an acrylic acid/acrylamide-2-methylpropanesulfonic acid copolymer (proportion of sulfonic acid group-containing monomers: 4% by mole, weight-average molecular weight: 4,000, solid content: 36% by weight, a product neutralized with sodium), to provide a polishing composition. The resulting polishing composition had a pH of 1.8.

### Example 6

The same procedures as in Example 5 were carried out except that the colloidal silica slurry of Example 3 was used as an abrasive, to provide a polishing composition. The resulting polishing composition had a pH of 1.7.

### Example 7

The same procedures as in Example 1 were carried out except that the copolymer was changed to an acrylic acid/acrylamide-2-methylpropanesulfonic acid copolymer (proportion of sulfonic acid group-containing monomers: 25% by mole, weight-average molecular weight: 4,000, solid content: 40% by weight, a product neutralized with sodium) was used, to provide a polishing composition. The resulting polishing composition had a pH of 1.8.

### Comparative Example 1

A polishing composition containing a colloidal silica slurry (commercially available from Du Pont K.K., average particle size of primary particles: 20 nm, concentration of silica particles: 40% by weight, and the balance being water) as abrasive, in an amount of 10.0% by weight based on net silica particles, and the balance being ion-exchanged water was prepared. The resulting polishing composition had a pH of 9.5.

### Comparative Example 2

The same procedures as in Example 1 were carried out except that a copolymer was not used to provide a polishing composition. The resulting polishing composition had a pH of 1.8.

### Comparative Example 3

A polishing composition containing a colloidal silica slurry (commercially available from Du Pont K.K., average particle size of primary particles: 20 nm, concentration of silica particles: 40% by weight, and the balance being water) as abrasive, in an amount of 10.0% by weight based on net silica particles, the copolymer of Example 1 in an amount of 0.10% by weight, and the balance being ion-exchanged water was prepared. The resulting polishing composition hadapHof9.5.

### Comparative Example 4

The same procedures as in Comparative Example 2 were carried out except that a colloidal silica slurry (commercially available from CATALYSTS & CHEMICALS INDUSTRIES CO., LTD., average particle size of primary particles: 80 nm, concentration of silica particles: 40% by weight, the balance being water) was used as an abrasive, to provide a polishing composition. The resulting polishing composition had a pH of 1.7.

### Comparative Example 5

The same procedures as in Example 1 were carried out except that a colloidal silica slurry (commercially available from CATALYSTS & CHEMICALS INDUSTRIES CO., LTD., average particle size of primary particles: 80 nm, concentration of silica particles: 40% by weight, the balance being water) was used as an abrasive, to provide a polishing composition. The resulting polishing composition had a pH of 1.8.

### Comparative Example 6

The same procedures as in Example 1 were carried out except that an acrylic acid/acrylamide-2-methylpropanesulfonic acid copolymer (proportion of sulfonic acid group-containing monomers: 12% by mole, weight-average molecular weight: 1,000, solid content: 40% by weight, a product neutralized with sodium) was used, to provide a polishing composition. The resulting polishing composition had a pH of 1.8.

The substrate to be polished was polished under the following conditions with each of the polishing compositions obtained in Examples 1 to 7 and Comparative Examples 1 to 6, and polishing rate and surface roughness (AFM-Ra) were determined and evaluated according to the following methods.

<<Polishing Conditions>>

Polishing testing machine: commercially available from Musasino Denshi K.K., MA-300 single-sided polishing machine, platen diameter: 300 mm
Polishing pad: Finish polishing pad made of an urethane
Rotational speed of platen: 90 r/min
Rotational speed of carrier: 90 r/min, forced driving type
Feeding rate for polishing composition: 50 g/min (about 2.5 mL/min/cm²)
Polishing time period: 15 min
Polishing load: 5.9 kPa (constant load with a dead weight)
Rinsing conditions: load: 3.9 kPa, time: 5 min, feeding rate for ion-exchanged
water: about 1 L/min
Dressing conditions: A brush dressing was carried out for 0.5 minutes in every cycle of polishing, while feeding ion-exchanged water.
   <<Evaluation Method of Substrate>>

Cleaning process: The substrate to be polished was taken out after the termination of polishing and rinsing, and cleaned under running water of ion-exchanged water. Next, the substrate was subjected to ultrasonic cleaning (100 kHz, 3 min), while being immersed in ion-exchanged water. The substrate was further cleaned under running water of ion-exchanged water, and dried by a spin-dry method.

Evaluation method: As surface roughness, AFM-Ra was determined with an atomic force microscope (AFM). The results are shown in Table 1.

<<Determination Method with AFM>>

Determination Apparatus: TM-M5E commercially available from Veeco

Mode: non-contact

Scan rate: 1.0 Hz

Scan area: 10 μm×10 μm

Evaluation method: Surface roughness was obtained by taking determinations at two scanning points near the midpoints of the inner circumference and the outer circumference on any center lines of a substrate, and obtaining an average thereof, which was used as AFM-Ra.

<<Method of Calculating Polishing Rate>>

A weight difference (g) in a substrate before and after polishing was divided by the density of the substrate (2.46 g/cm³), the surface area of the substrate (30.04 cm²) and the polishing time (minute), to provide a polished amount per unit time, and polishing rate (μm/minute) was calculated. The results are shown in Table 1.

TABLE 1

| | | | Acrylic Acid/Sulfonic Acid Copolymer | | | | | |
|---|---|---|---|---|---|---|---|---|
| | Silica | | | Ratio of Sulfonic | | | | |
| | Average | | Weight- | Acid Group- | | | | Surface |
| | Particle | | Average | Containing | | | Polishing | Roughness |
| | Size | Content | Molecular | Monomer | Content | | Rate | [AFM-Ra] |
| | (nm) | (% by wt.) | Weight | (% by mole) | (% by wt.) | pH | (μm/min) | (nm) |
| Ex. 1 | 20 | 5.0 | 2,000 | 11 | 0.10 | 1.8 | 0.035 | 0.175 |
| Ex. 2 | 20 | 5.0 | 2,000 | 11 | 0.10 | 3.0 | 0.031 | 0.170 |
| Ex. 3 | 30 | 5.0 | 2,000 | 11 | 0.10 | 1.7 | 0.043 | 0.185 |
| Ex. 4 | 30 | 5.0 | 2,000 | 11 | 0.05 | 1.8 | 0.041 | 0.189 |
| Ex. 5 | 20 | 5.0 | 4,000 | 4 | 0.10 | 1.8 | 0.033 | 0.173 |
| Ex. 6 | 30 | 5.0 | 4,000 | 4 | 0.10 | 1.7 | 0.040 | 0.188 |
| Ex. 7 | 20 | 5.0 | 4,000 | 25 | 0.10 | 1.8 | 0.035 | 0.172 |
| Comp. | 20 | 10.0 | — | — | — | 9.5 | 0.010 | 0.174 |
| Ex. 1 | | | | | | | | |
| Comp. | 20 | 5.0 | — | — | — | 1.8 | 0.033 | 0.222 |
| Ex. 2 | | | | | | | | |
| Comp. | 20 | 10.0 | 2,000 | 11 | 0.10 | 9.5 | 0.010 | 0.170 |
| Ex. 3 | | | | | | | | |
| Comp. | 80 | 5.0 | — | — | — | 1.7 | 0.050 | 0.287 |
| Ex. 4 | | | | | | | | |
| Comp. | 80 | 5.0 | 2,000 | 11 | 0.10 | 1.8 | 0.053 | 0.253 |
| Ex. 5 | | | | | | | | |
| Comp. | 20 | 5.0 | 10,000 | 12 | 0.10 | 1.8 | 0.024 | 0.175 |
| Ex. 6 | | | | | | | | |

It can be seen from the results in Table 1 that the polishing compositions obtained in Examples 1 to 7 meet a satisfactory level for both high polishing rates and excellent surface qualities, as compared to those of Comparative Examples 1 to 6.

2. Photomask Substrate

<<Substrate to Be Polished>>

A synthetic quartz substrate (commercially available from Opto-star), having a diameter of 50 mm+, and a thickness of 0.9 mm, previously subjected to a first polishing step with a polishing composition containing ceria as an abrasive so as to provide a surface roughness AFM-Ra of 0.3 nm was used as a substrate to be polished.

### Example 8

The same procedures as in Example 1 were carried out, to provide a polishing composition.

### Example 9

The same procedures as in Example 2 were carried out, to provide a polishing composition.

### Comparative Example 7

The same procedures as in Comparative Example 1 were carried out, to provide a polishing composition.

### Comparative Example 8

The same procedures as in Comparative Example 3 were carried out, to provide a polishing composition.

Polishing was carried out using each of the polishing compositions obtained in Examples 8 and 9 and Comparative Examples 7 and 8 under the following conditions, and the polishing rate and the surface roughness (AFM-Ra) were determined and evaluated on the bases of the following methods.

<<Polishing Conditions>>

The substrate to be polished was polished in the same manner as 1. Glass Hard Disk Substrate mentioned above, except that a polishing load was changed to 13.5 kPa (constant load with a dead weight).

<<Evaluation Method of Substrate>>

The cleaning process, the evaluation method, and the determination method with AFM were carried out in the same manner as 1. Glass Hard Disk Substrate mentioned above. The results are shown in Table 2.

<<Method of Calculating Polishing Rate>>

A weight difference (g) in a substrate before and after polishing was divided by the density of the substrate (2.20 g/cm³), the surface area of the substrate (19.63 cm²) and the polishing time (minute), to provide a polished amount per unit time, and polishing rate (μm/minute) was calculated. The results are shown in Table 2.

TABLE 2

| | | | Acrylic Acid/Sulfonic Acid Copolymer_{—} | | | | | |
|---|---|---|---|---|---|---|---|---|
| | Silica | | | Ratio of Sulfonic | | | | |
| | Average | | Weight- | Acid Group- | | | | Surface |
| | Particle | | Average | Containing | | | Polishing | Roughness |
| | Size | Content | Molecular | Monomer | Content | | Rate | [AFM-Ra] |
| | (nm) | (% by wt.) | Weight | (% by mole) | (% by wt.) | pH | (μm/min) | (nm) |
| Ex. 8 | 20 | 5.0 | 2,000 | 11 | 0.10 | 1.8 | 0.054 | 0.097 |
| Ex. 9 | 20 | 5.0 | 2,000 | 11 | 0.10 | 3.0 | 0.058 | 0.117 |
| Comp. | 20 | 10.0 | — | — | — | 9.5 | 0.032 | 0.080 |
| Ex. 7 | | | | | | | | |
| Comp. | 20 | 5.0 | — | — | — | 1.8 | 0.033 | 0.086 |
| Ex. 8 | | | | | | | | |

It can be seen that the polishing compositions obtained in Examples 8 and 9 satisfy both high polishing rates and excellent surface quality, as compared to those of Comparative Examples 7 and 8.

The polishing composition for a glass substrate of the present invention can be suitably used, for example, in the manufacture of glass hard disks, aluminosilicate glass for reinforced glass substrates, glass ceramic substrates (crystallized glass substrate), synthetic quartz glass substrate (photomask substrate), and the like.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A polishing composition for a glass substrate having a pH of from 0.5 to 5, comprising a silica of which primary particles have an average particle size of from 5 to 50 nm and an acrylic acid/sulfonic acid copolymer having a weight-average molecular weight of from 1,000 to 5,000.

2. The polishing composition according to claim 1, wherein a sulfonic acid group-containing monomer is contained in a ratio of from 3 to 90% by mole of all the monomers constituting the acrylic acid/sulfonic acid copolymer.

3. The polishing composition according to claim 1, wherein the silica and the copolymer are contained in the polishing composition in a concentration ratio (concentration of the silica (% by weight)/concentration of the copolymer (% by weight)) of from 10 to 5,000.

4. The polishing composition according to claim 2, wherein the silica and the copolymer are contained in the polishing composition in a concentration ratio (concentration of the silica (% by weight)/concentration of the copolymer (% by weight)) of from 10 to 5,000.

5. The polishing composition according to claim 1, wherein the silica is a colloidal silica.

6. The polishing composition according to claim 2, wherein the silica is a colloidal silica.

7. The polishing composition according to claim 3, wherein the silica is a colloidal silica.

8. The polishing composition according to claim 4, wherein the silica is a colloidal silica.

9. A method for manufacturing a glass substrate, comprising the step of polishing a substrate to be polished with a polishing load of from 3 to 12 kPa while allowing the polishing composition as defined in claim 1 to be present between a polishing pad and the substrate to be polished.

10. A method for manufacturing a glass substrate, comprising the step of polishing a substrate to be polished with a polishing load of from 3 to 12 kPa while allowing the polishing composition as defined in claim 2 to be present between a polishing pad and the substrate to be polished.

11. A method for manufacturing a glass substrate, comprising the step of polishing a substrate to be polished with a polishing load of from 3 to 12 kPa while allowing the polishing composition as defined in claim 3 to be present between a polishing pad and the substrate to be polished.

12. A method for manufacturing a glass substrate, comprising the step of polishing a substrate to be polished with a polishing load of from 3 to 12 kPa while allowing the polishing composition as defined in claim 4 to be present between a polishing pad and the substrate to be polished.

13. The method according to claim 9, wherein the glass substrate is a glass hard disk substrate.

14. The method according to claim 10, wherein the glass substrate is a glass hard disk substrate.

15. The method according to claim 11, wherein the glass substrate is a glass hard disk substrate.

16. The method according to claim 12, wherein the glass substrate is a glass hard disk substrate.

17. The method according to claim 9, wherein the glass substrate is a photomask substrate.

18. The method according to claim 10, wherein the glass substrate is a photomask substrate.

19. The method according to claim 11, wherein the glass substrate is a photomask substrate.

20. The method according to claim 12, wherein the glass substrate is a photomask substrate.

21. The method according to claim 9, wherein the glass substrate is a quartz wafer substrate.

22. The method according to claim 10, wherein the glass substrate is a quartz wafer substrate.

23. The method according to claim 11, wherein the glass substrate is a quartz wafer substrate.

24. The method according to claim 12, wherein the glass substrate is a quartz wafer substrate.
